(19) United States
(12) Patent Application Publication
(10) Pub. No.: US 2015/0066391 A1
(43) Pub. Date: Mar. 5, 2015

(54) METHODS FOR CHARACTERIZING DENTS IN PIPELINES

(71) Applicant: TransCanada Pipelines Limited, Calgary (CA)

(72) Inventor: Rick Yahua WANG, Calgary (CA)

(73) Assignee: TransCanada Pipelines Limited, Calgary (CA)

(21) Appl. No.: 14/014,848

(22) Filed: Aug. 30, 2013

(51) Int. Cl. G01N 27/82; G01B 7/24

(52) U.S. Cl. CPC G01N 27/82; G01B 7/24
USPC 702/38; 324/240

(57) ABSTRACT

The disclosure describes methods, devices and tools useful in the non-destructive inspection and the characterization of mechanical damage such as dents in pipelines. Methods, devices and tools described herein make use of a strain severity indication combined with a material loss indication such as magnetic flux leakage to determine whether a dent comprises at least one of a crack, a gouge and corrosion. The characterization of the mechanical damage in dents of pipes may be used to determine whether and when any corrective or preventive action should be carried out.

### TECHNICAL FIELD

The disclosure relates generally to pipeline inspection, and more particularly to the characterization of dents in pipelines.

### BACKGROUND OF THE ART

Current in-line inspection (ILI) technologies including dimensional inspection and magnetic flux leakage (MFL) measurements are used for inspection of damage in pipelines but are either incapable of discriminating, or have limited ability to discriminate between the types of damage with certainty. Without discrimination of the type of damage, current ILI technologies using existing analysis methods may, in some instances, fail to report damage that would otherwise require preventive or corrective action. Alternatively, current ILI technologies using existing analysis can sometimes result in reporting damage that is too conservative and consequently result in costly and unnecessary preventive or corrective actions being carried out.

Improvement is therefore desirable.

### SUMMARY

The disclosure describes methods, devices and tools useful in the non-destructive inspection of materials of structures such as pipelines. For example, the methods, devices and tools disclosed herein may be used to characterize damage in metallic pipes. Such characterization of damage may include the characterization of dents in pipelines to discriminate between dents including cracks, dents including gouges and dents including corrosion. In some embodiments, the methods, devices and tools described herein may make use of a strain severity indication combined with a metal loss indication (e.g., magnetic flux leakage) to determine whether a dent comprises at least one of a crack and a gouge.

In one aspect, the disclosure describes a method for characterizing a dent in a material where the material may be part of a pipeline or other structure. The method may comprise:

using a first measuring device, acquiring one or more first measurements indicative of strain in the pipeline in a region of the dent;

using a second measuring device, acquiring one or more second measurements indicative of a material loss in the region of the dent; and

conditioned upon the strain meeting a first criterion and the material loss meeting a second criterion, determining that the dent comprises at least one of a crack and a gouge based on a combination of the first criterion and of the second criterion.

In another aspect, the disclosure describes a method, which may comprise:

acquiring one or more measurements indicative of strain in a region of a metallic pipe comprising a dent;

determining whether the strain meets a first criterion;

acquiring one or more magnetic flux leakage measurements in the region of the metallic pipe comprising the dent;

determining whether the one or more magnetic flux leakage measurements meet a second criterion;

conditioned upon the strain meeting the first criterion and the one or more magnetic flux leakage measurements meeting the second criterion:
determining that the dent comprises at least one of a crack and a gouge based on a combination of the first criterion and of the second criterion; and
determining whether one or more corrective or preventive actions are required; and

conditioned upon the one or more corrective or preventive actions being required, carrying out the one or more corrective or preventive actions.

In another aspect, the disclosure describes a computer-implemented method for characterizing a dent in a material where the material may be part of a pipeline or other structure. The method may comprise:

receiving one or more first signals indicative of strain in the material in a region of the dent;

processing the received first signals to determine whether the strain meets a first criterion;

receiving one or more second signals indicative of material loss in the region of the dent;

processing the received second signals to determine whether the material loss meets a second criterion; and

conditioned upon the strain meeting the first criterion and the material loss meeting the second criterion, generating one or more signals characterizing the dent as comprising at least one of a crack and a gouge based on the combination of the first criterion and of the second criterion.

In a further aspect, the disclosure describes machine-readable instructions that, when executed by one or more processors, cause such processor(s) to execute at least portions of the methods disclosed herein.

Further details of these and other aspects of the subject matter of this application will be apparent from the detailed description and drawings included below.

### DESCRIPTION OF THE DRAWINGS

Reference is now made to the accompanying drawings, in which:

FIG. 1 is an axial cross-sectional view of a pipe showing a schematic representation of an in-line inspection tool being passed inside the pipe;

FIG. 2 is a schematic diagram showing a processor configured to generate dent characterization data based on strain data and magnetic flux leakage data;

FIG. 3 shows a flowchart of an exemplary method for characterizing a dent in a metallic pipe;

FIG. 4A shows a flowchart of another exemplary method for characterizing a dent in a metallic pipe;

FIG. 4B shows a flowchart of another exemplary method for characterizing a dent in a metallic pipe;

FIG. 5 shows a flowchart of another exemplary method for characterizing a dent in a metallic pipe;

FIG. 6A shows a plot of a maximum equivalent strain in a first exemplary dent against the axial distance along a pipe;

FIG. 6B is a top view, grayscale screen shot of magnetic flux leakage data for the first exemplary dent;

FIG. 6C is a side view, grayscale screen shot of magnetic flux leakage data for the first exemplary dent;

FIGS. 6D and 6E show an excavated region of the pipe comprising the first exemplary dent;

FIGS. 6F and 6G show images of cracks associated with the first exemplary dent on the outside and the inside of a wall of the pipe respectively;

FIG. 7A shows a plot of a maximum equivalent strain in a second exemplary dent against the axial distance along a pipe;

FIG. 7B is a top view, grayscale screen shot of magnetic flux leakage data for the second exemplary dent;

FIG. 7C is a side view, grayscale screen shot of magnetic flux leakage data for the second exemplary dent;

FIG. 7D shows an image of a gouge associated with the second exemplary dent;

FIG. 7E shows an image of the gouge of FIG. 7D at higher magnification;

FIG. 8A shows a plot of a maximum equivalent strain in a third exemplary dent against the axial distance along a pipe;

FIG. 8B is a top view, grayscale screen shot of magnetic flux leakage data for the third exemplary dent;

FIG. 8C is a side view, grayscale screen shot of magnetic flux leakage data for the third exemplary dent;

FIG. 8D shows an image of an excavated region of the pipe comprising the third exemplary dent;

FIG. 8E shows an image of a crack associated with the third exemplary dent;

FIG. 9A shows a plot of a maximum equivalent strain in a fourth exemplary dent against the axial distance along a pipe;

FIG. 9B is a top view, grayscale screen shot of magnetic flux leakage data for the fourth exemplary dent;

FIG. 9C is a side view, grayscale screen shot of magnetic flux leakage data for the fourth exemplary dent;

FIG. 9D shows an image of an excavated region of the pipe comprising the fourth exemplary dent;

FIG. 9E shows images of a crack associated with the fourth exemplary dent;

FIG. 10A shows a plot of a maximum equivalent strain in a fifth exemplary dent against the axial distance along a pipe;

FIG. 10B is a grayscale screen shot of axial magnetic flux leakage data for the fifth exemplary dent;

FIG. 10C shows an image of an excavated region of the pipe comprising the fifth exemplary dent; and

FIG. 10D shows an image of a crack associated with the fifth exemplary dent.

### DETAILED DESCRIPTION

Aspects of various embodiments are described through reference to the drawings.

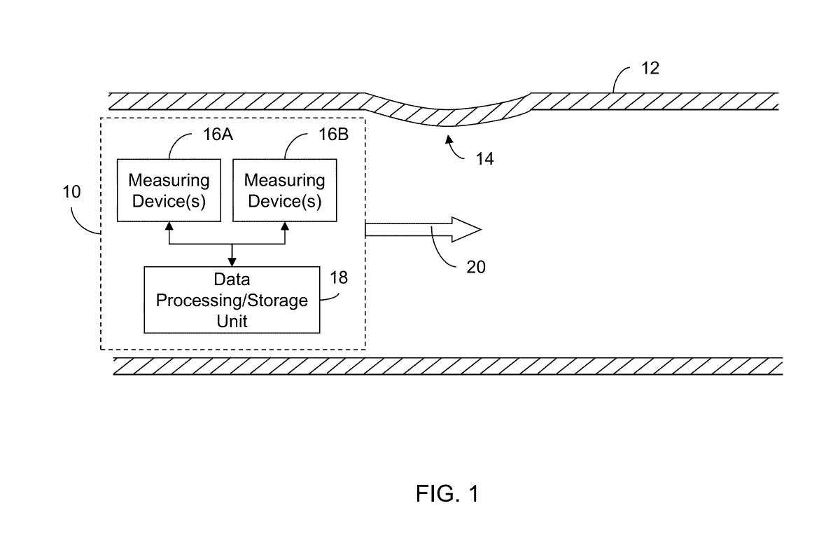

FIG. 1 schematically shows in-line inspection (ILI) tool 10 that may be used to conduct in-situ non-destructive inspection of pipe 12, which may be part of a pipeline. Pipe 12, may, for example, be part of a natural gas pipeline, an oil pipeline or other type of pipeline. Pipe 12 may comprise a metallic material such as a suitable American Petroleum Institute (API) grade steel or other type of material suitable for the particular use for pipe 12. Inspection tool 10 may be of a type commonly referred to as a pig that is passed inside a portion of pipeline (e.g., pipe 12) to be inspected and may be used to detect defects using known or other non-destructive testing techniques. As described further below, inspection tool 10, may be configured to detect one or more types of defects including, for example, corrosion, cracks, dents, gouges and/or other types mechanical damage or metal loss (i.e., missing material). For example, the defect may include one or more dents 14 as shown in FIG. 1 and which may include one or more of a crack, a gouge, corrosion and/or other type of material loss such as surface breaks and/or manufacturing defects.

Pipelines constructed in mountain or rocky territory can be vulnerable to damages such as denting. ILI of such pipelines can sometimes report thousands of dent features over a significant length of pipe 12. Some of the dent features detected may be plain dents or may be associated with corrosion, gouge and/or cracks. Current ILI technologies are typically incapable, or have limited capability, of discriminating between dents containing corrosion, cracks, gouges and/or other surface breaks and/or manufacturing defects. Accordingly, ILI service providers generally report such dents 14 as being simply associated with metal loss without distinguishing the type of metal loss. The type of metal loss associated with dent(s) 14 can be an important piece of information for an owner, operator, custodian or other party responsible for the operation and/or maintenance of a pipeline. For example, the type of metal loss associated with dent(s) 14 may be used to determine whether any corrective or preventive action is required and when such corrective or preventive action should be carried out. For example, a dent associated with corrosion may be assessed separately as per ASME B31.8 guidelines, which are incorporated herein by reference, to determine the severity of the defect and also determine whether and when a corrective or preventive action is required. However, dent(s) 14 associated with one or more cracks or gouges could pose immediate threat to pipeline integrity and could require immediate attention. Corrective or preventive actions could include an evaluation such as a visual inspection and/or a full integrity inspection of pipe 12, repair and/or replacement of at least a portion of pipe 12. Accordingly, in cases where pipe 12 may be buried underground, such corrective or preventive actions may include excavation to provide access to at least a portion of damaged pipe 12.

According to some embodiments of the present disclosure, tools, devices and methods disclosed herein may be useful in discriminating between dents 14 associated with corrosion, surface breaks and/or manufacturing defects, cracks and/or gouges. For example, ILI tool 10 may comprise one or more measuring devices 16A and 16B that may serve to acquire measurements useful in identifying defects inside pipe 12. Measuring devices 16A, 16B may comprise the same or different types of sensors that may be used to acquire data of the same or different types to measure different characteristics of mechanical defects in pipe 12. Measuring devices 16A, 16B may be configured to acquire measurements that may be useful in characterizing defects such as dent 14 in pipe 12.

For example, measuring device 16A may be configured to acquire one or more first measurements indicative of strain(s) in the material of pipe 12 in the region of dent 14. In some embodiments, measuring device 16A may be configured to acquire one or more measurements indicative of deformation (i.e., a geometry) of dent 14 so that the strain(s) associated with the dent 14 may be inferred from the geometry of the dent according to known or other methods. In any event, measuring device 16A may be configured to acquire one or more measurements from which strain information about dent 14 may be obtained directly or indirectly. In some embodiments, measuring device 16A may comprise a caliper of known or other types that may be used to acquire geometric information related to dent 14. It is understood that measuring device 16A may comprise any suitable type of sensor(s) configured to conduct any measurement technique(s) suitable for obtaining an indication of the strain(s) in the region of dent 14.

Measuring device 16B may be configured to acquire one or more second measurements indicative of a material loss in the region of dent 14. For example, such indication of material loss may be indicative of the presence of one or more cracks, gouges, corrosion, surface break(s), manufacturing defects and/or voids in the region of dent 14. In some embodiments, measuring device 16B may be configured to acquire magnetic flux leakage (MFL) measurements which may be indicative of such material loss. MFL measurements may, for example, be suitable when pipe 12 comprise a magnetic metallic material such as an API grade steel. MFL measurements may be taken along one or more magnetic directions if desired. For example, measuring device 16B may be configured to acquire axial and/or tri-axial MFL measurements. It is understood that measuring device 16B may comprise any suitable type of sensor(s) configured to conduct any measurement technique(s) suitable for obtaining an indication of material loss in the material of pipe 12 in the region of dent 14.

In some embodiments, ILI tool 10 may comprise some data processing capabilities. For example, ILI tool 10 may comprise one or more data processing/storage units 18, which may provide one or more of a control function within ILI tool 10; a data processing function and a data storage function. While, data processing/storage unit 18 is shown as being within ILI tool 10 disposed inside pipe 12, it is understood that data processing/storage unit 18 could instead be disposed remotely from ILI tool 10 while still being in communication with ILI tool 10 via wired and/or wireless connection(s). For example, data processing/storage unit 18 may serve to control one or more operations of certain components such as one or more of measuring devices 16A, 16B of ILI tool 10. In some embodiments, data processing/storage unit 18 may be operatively coupled to one or more of measuring devices 16A, 16B so that signals generated by measuring devices 16A, 16B may be processed and/or stored by data processing/storage unit 18 for later processing and analysis. Data processing/storage unit 18 may be configured to conduct detailed or preliminary analysis of the signals provided by measuring devices 16A, 16B. Alternatively, data processing/storage unit 18 may be configured to conduct only minimal to no analysis on the signals generated by measuring devices 16A, 16B and may instead primarily serve a data storage function for data representative of the measurements acquired with measuring devices 16A, 16B.

ILI tool 10 may also be configured to track its position along pipe 12. In some embodiments, data collected from one or more of measuring devices 16A, 16B may be associated with a position along pipe 12 including, axial, radial and/or circumferential information related to pipe 12, so that measurements acquired by measuring devices 16A, 16B, may be correlated to a position within pipe 12. For example, the position information associated with measurements obtained from measuring devices 16A, 16B may also serve to correlate (e.g., superimpose, compare) measurements from two or more of measuring devices 16A, 16B to each other.

During use (e.g., in-line inspection), ILI tool 10 may be used to detect defects such as dent(s) 14 in pipe 12. For example ILI tool 10 may be passed through of pipe 12 along arrow 20 and one or more measuring devices 16A, 16B may acquire measurements that may later be used to characterize dent 14. As mentioned above, measuring device 16A may acquire one or more first measurements indicative of strain(s) in the pipe material in the region of dent 14 and measuring device 16B may acquire one or more second measurements indicative of metal loss.

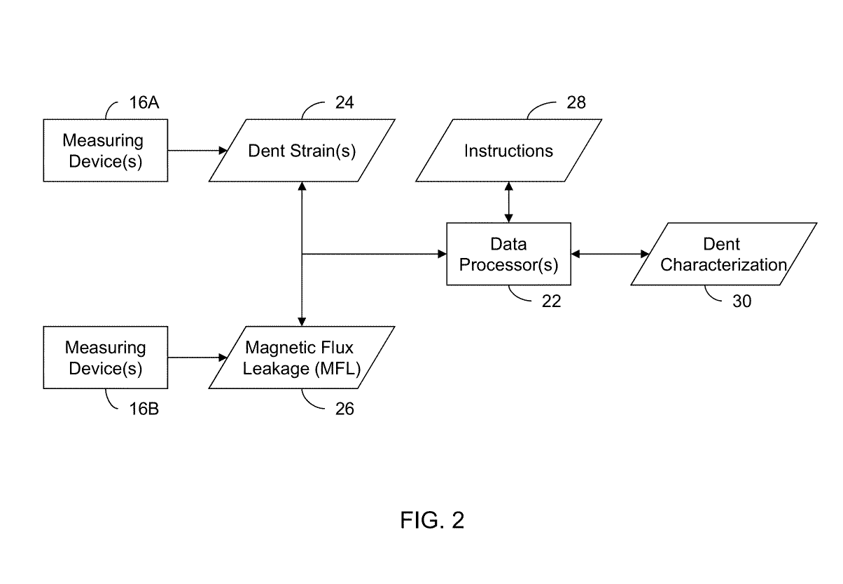

FIG. 2 schematically shows a one or more processors 22 configured to receive signals indicative of strain data 24 in the material of pipe 12 in the region of dent 14 and signals indicative material loss data 26 (e.g., MFL data) and, based on instructions 28, generate one or more signals indicative of dent characterization data 30. Characterization data 30 may, for example, comprise an indication of whether dent 14 comprises one or more of cracks, gouges, corrosion, surface breaks and/or manufacturing defects. Strain data 24, MFL data 26, instructions 28 and characterization data 30 may be retrievably stored on suitable memory(ies) including any storage means (e.g., devices) suitable for access by data processor(s) 22. Such memory(ies) may comprise electromagnetic or solid state media suitable for storing electronic data signals in volatile or non-volatile, non-transient form. Instructions 28 may comprise machine readable instructions executable by processor(s) 22 to conduct suitable processing and analysis of strain data 24, MFL data 26 and optionally other data in accordance with the methods disclosed in the present disclosure.

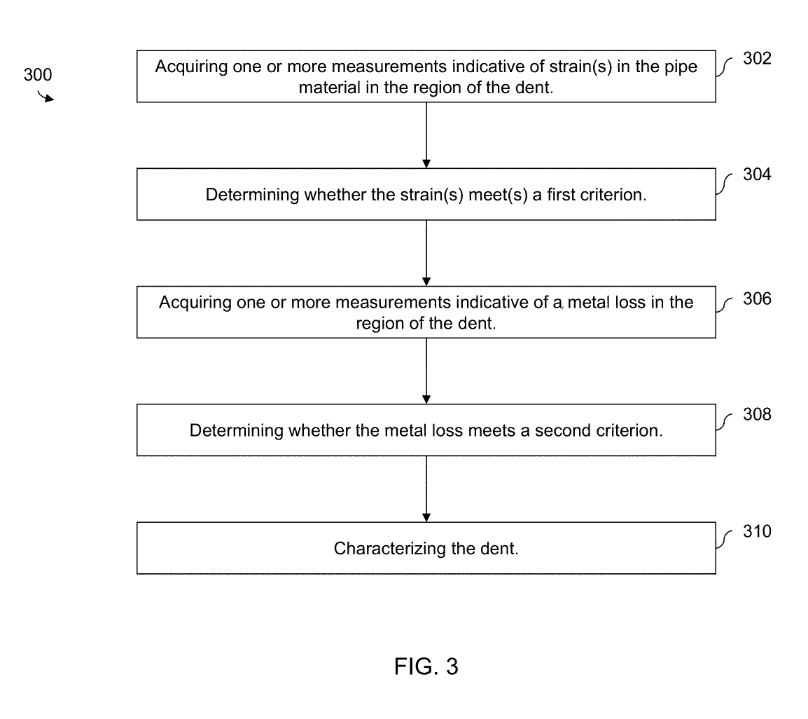

FIG. 3 shows a flowchart of an exemplary method 300 for characterizing dent 14. For example, dent 14 may be part of pipe 12 or some other structure. Method 300 may comprise: acquiring one or more measurements indicative of strain(s) in the pipe in a region of dent 14 (see block 302); determining whether the strain(s) meet(s) a first criterion (see block 304); acquiring one or more measurements indicative of a metal loss in the region of dent 14 (see block 306); determining whether the metal loss meets a second criterion (see block 308); and, characterizing the dent (see block 310). In various embodiments, the characterization of the dent may comprise, conditioned upon the strain meeting the first criterion and the material loss meeting the second criterion, determining that dent 14 comprises at least one of a crack and a gouge based on a combination of the first criterion and of the second criterion. For example, in some embodiments, the characterization of dent 14 may comprise determining that dent 14 comprises either a crack or a gouge based on a combination of the first criterion and of the second criterion. The one or more measurements indicative of strain(s) may, for example, be acquired using measuring device 16A. The evaluation of the first (e.g., strain severity) criterion may comprise the determination of one or more maximum strain values within dent 14. The one or more measurements indicative of metal loss may, for example, be acquired using measuring device 16B. In various embodiments, the characterization of the dent may comprise, conditioned upon the metal loss comprising a plurality of metal loss indications distributed within dent 14, determining that dent 14 comprises corrosion.

While the acquisition of the measurements may be conducted using measuring devices 16A, 16B, some or all other portions of method 300 may, in some embodiments, be executed by a computer, which may include data processor(s) 22 configured to execute instructions 28. For example, signals representative of the measurements obtained from measuring devices 16A and 16B may be received by processor(s) 22 and processed in accordance with instructions 28 in order to generate output signals representative of characterization of dent 14 (see dent characterization data 30 shown in FIG. 2).

Method 300 may comprise fewer or additional blocks or aspects than those shown in FIG. 3. For example, The one or more measurements indicative of metal loss may comprise one or more MFL measurements acquired via measuring device 16B. The first criterion may comprises a strain severity criterion which may be indicative of the likelihood of cracking or other type of damage that may require preventive or corrective action. The strain severity criterion may be based on the dent geometry and may be used to make an inference about the severity of dent 14 from its geometry.

Dent 14 may comprise permanent damage of pipe 12 by local plastic deformation of the material of pipe 12. Dent severity and its susceptibility to cracking, may be assessed using a plastic damage criterion. For example, a dent with relatively high strain(s) could potentially be associated with one or more cracks. Strain based assessment models are increasingly accepted and used in the pipeline industry to determine the dent severity for prioritizing field investigation and remediation. ASME B31.8 Appendix R, incorporated herein by reference, provides a non-mandatory strain assessment procedure and other methods may also be available in literature. Strain models often utilize axial and circumferential profiles of a dent reported by suitable multi-channel ILI geometry tools, which can calculate the component strains, bending and membrane strain both in the axial and circumferential directions as well as the combined total, or equivalent strain for each point reported by the ILI tool within the dent. Then, the maximum equivalent strain of the dent may be identified and compared with a strain acceptance limit as per ASME B31.8 or other qualified strain limit criteria. The strain-based approach can eliminate or minimize dent depth discrepancies due to, in general, poor correlation with mechanical damage.

The strain severity criterion may be based on the material and/or mechanical properties of the material comprised in pipe 12. For example, the strain severity criterion may be based on a threshold elongation permissible for the material under the particular conditions to which pipe 12 may be exposed. Accordingly, the strain severity criterion may be selected based on the ductility of the material including in one or more body and/or weld portions of pipe 12. The strain severity criterion may in addition be selected based on the environmental conditions to which the material is exposed and may take into consideration temperature and corrosion factors. One skilled in the relevant arts will recognize that suitable strain severity criteria may be selected for different applications based on the particular operating conditions and pipe material(s).

In some embodiments, it may be appropriate for the first criterion to be based on a suitable ductile failure damage indicator (DFDI) of known or other types. For example, a suitable upper bound DFDI may be defined as:

$$DFDI = \frac{{ɛ}_{eq , m ax}}{( \frac{{ɛ}_{0}}{1.65} )} \qquad ( equation 1 )$$

where ε_{eq,max} is a maximum equivalent (geometric) strain calculated from the one or more measurements indicative of the strain(s) in the material in the region of dent 14 and ε₀ is a critical (true) strain (e.g., a mechanical property) of the material. The critical strain ε₀ may be obtained from mechanical testing and may be in the range of 0.3 to 0.5 for metallic materials typically used in pipeline applications. For example, ε₀ may be obtained from uni-axial tensile testing and the value of 1.65 may be a constant that is based on the fact that ε₀ was obtained via uni-axial tensile testing. The maximum equivalent strain ε_{eq,max} may be determined from the measured geometric profile of dent 14. Accordingly, the DFDI defined in equation 1 above may be used as an upper bound strain severity criterion to assess the severity of dent 14 and determine whether further characterization of dent 14 is required.

The first criterion may be met when the DFDI value computed using equation 1 has reached or has exceeded a predetermined value. In the exemplary DFDI shown above, a DFDI value equal to or in excess of about one (1) may be an indication that the material is susceptible to cracking. Accordingly, in some applications, it may be prudent to define the first criterion as a DFDI value that is less than one to allow for a safety margin. For example, it may be appropriate in some applications to define the first criterion as a DFDI value equal to or exceeding about 0.6. One skilled in the art will recognize that the first criterion could be set at lower or higher values depending on the confidence level and certainty of the measurement(s) obtained from one or more of measuring devices 16A and/or 16B, on the particular application and also depending on potential consequences that could be associated with a loss of integrity of pipe 12.

The first criterion may not necessarily rely on the DFDI value but it is understood that, in various embodiments of the present disclosure, other types of criteria could also be used. For example, the meeting of the first criterion could, instead of or in addition to the DFDI, simply comprise a threshold strain value that has been met or exceeded. In such embodiments, a maximum strain value measured in dent 14 could be compared with such threshold strain value to determine whether the strain criterion has been met.

The second criterion may be associated with a metal loss indication and may be combined with the first (e.g., strain severity) criterion in order to characterize dent 14. For example, the strain indication and the metal loss indication may be combined to determine whether dent 14 may comprise one or more of a crack, a gouge, and/or corrosion. Due at least in part to the acquisition of both types of measurements and also the associated position along the pipe at which the measurements may have been taken, both types of measurements may be correlated so that the strain and metal loss indications may be combined (e.g., superimposed) at specific positions in the region of dent 14.

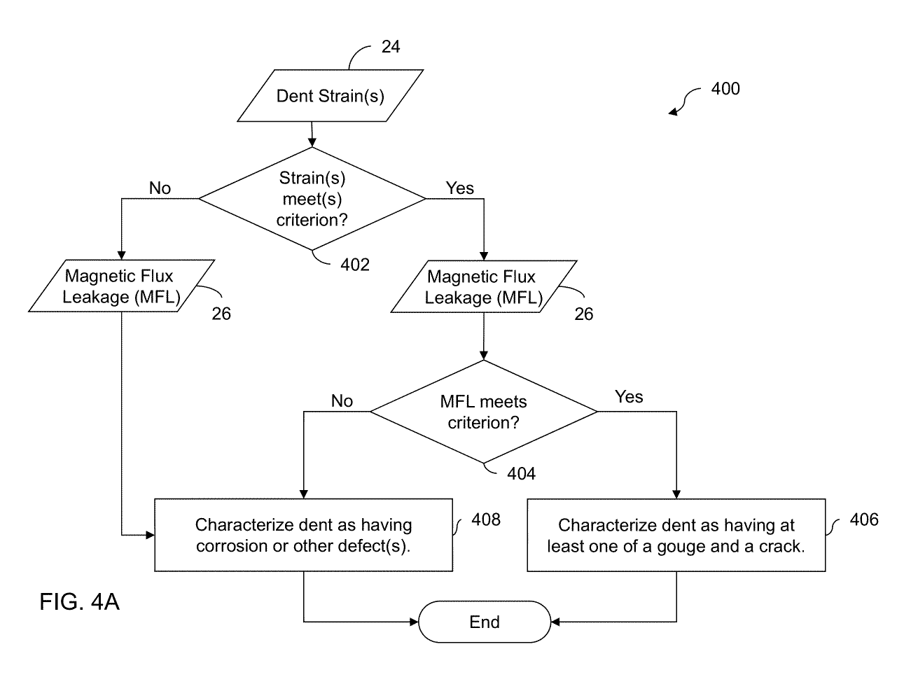

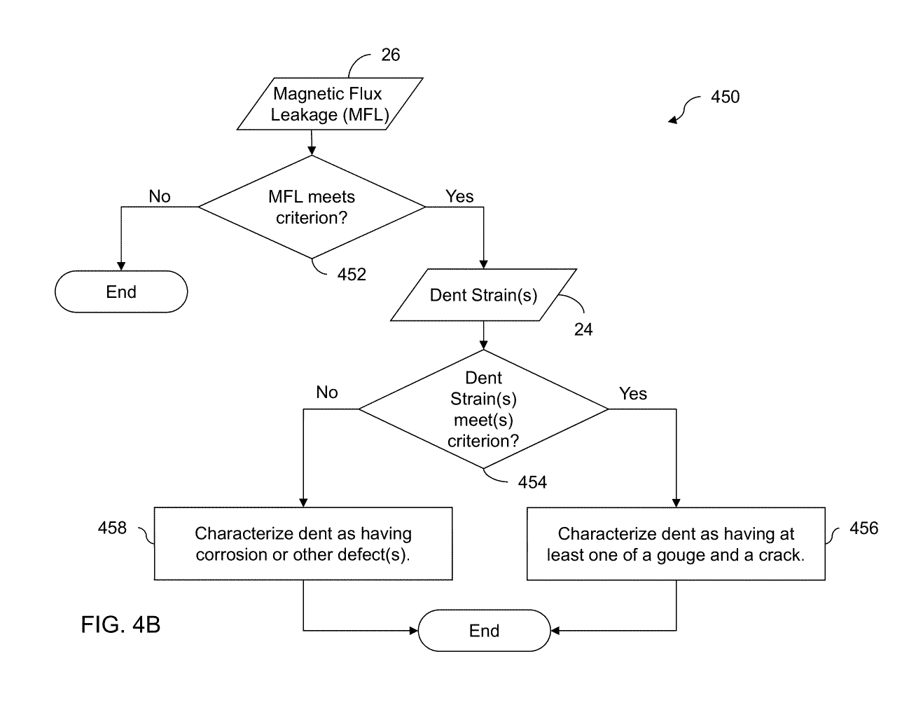

In various embodiments of the present disclosure, the second (e.g., metal loss) criterion may only be considered once the first (e.g., strain) criterion has been met. However, in various embodiments, the first and second criteria may be considered in the reverse order and therefore the references made herein to “first” and “second” criteria may not necessarily mean or imply a particular order unless specifically stated otherwise. As explained below in reference to FIGS. 4A and 4B, the metal loss data could be considered first and the strain data could be considered subsequently if a material loss criterion has been met. In some embodiments, the metal loss criterion may be evaluated conditioned upon the strain criterion having been met and in other embodiments the strain criterion may be evaluated conditioned upon the metal loss criterion having been met. In some embodiments, the metal loss criterion and the strain criterion may be evaluated independently of each other regardless of whether one or the other has been met. Additional data and one or more criteria could also be considered in the characterization of dent 14.

Methods according to the present disclosure may incorporate a combined approach considering material loss measurements such as MFL signals for one or more dents 14 that have met the strain severity criterion described above. In existing methods, when MFL signal(s) acquired are below a certain threshold, a dent may be reported as a plain dent. In other cases, MFL signals may meet a reportable threshold but existing ILI tools and methods may be incapable of differentiating or discriminating cracking/gouging from corrosion based on MFL signal(s) alone. Hence, such reportable MFL signals may be simply reported as metal loss without further characterization. In some cases, due to the lack of further characterization of MFL signals, such signals can sometimes be dismissed even though they may, in reality, represent a reportable defect requiring preventive or corrective action.

The combination of MFL data 26 with strain data 24 presented in the present disclosure may provide further insight into the damage associate with dent 14. For example, some features of MFL data 26 in combination with strain data 24 may indicate that dent 14 likely comprises one or more cracks. Accordingly, in some embodiments, methods disclosed herein may combine the characterizations of strain data 24 with (e.g., axial, tri-axial) MFL data 26 signal to identify potential risks of otherwise characterized “plain” dents containing cracks and also discriminating cracking and/or gouging from general metal loss indications.

Table 1 below shows exemplary characterizations of dent 14 based on the combination of strain and MFL measurements. The exemplary criteria disclosed herein and used for the characterization of dents may provide an indication of the likelihood of dent 14 comprising specific features that may require the initiation of one or more preventive or corrective actions. It is noted that the terms “strong”, “high”, “weak”, “low” and “moderate” used herein are relative terms and may be used to refer to different relative magnitudes within a range of measured values within a region of material being considered, such as the region of dent 14. For example, material strain measurements acquired within the region of dent 14 may comprise values that spread over a range and that range may be divided (equally or otherwise) into three (3) different categories referenced as low, moderate and high. Similarly, material loss (e.g., material loss) measurements acquired within the region of dent 14 may comprise values that spread over a range and that range may be divided (equally or otherwise) into three (3) different categories referenced as weak, moderate and strong.

The dent characterizations or classifications presented in Table 1 below may be made based on the combination of the strain severity (i.e., first criterion) and also the metal loss (i.e., second criterion). The material loss indications presented in Table 1 may comprise MFL measurements. It is also understood that while other exemplary methods are described below, the examples of first and second criteria described above may be used in conjunction with the other methods described in the present disclosure. As illustrated in Table 1, the analysis of the metal loss indications may comprise determining a number of metal loss features/indications within the region of dent 14, for example, and determining whether such metal loss feature(s)/indication(s) is/are isolated, clustered or dispersed within the region of dent 14.

TABLE 1
Dent Characterization

| Combination of Strain and Material Loss | Dent |
|---|---|
| Indications | Characterization |
| A substantially isolated (e.g., single) strong | The dent likely |
| metal loss indication located at the apex of the | comprises a crack. |
| dent or the region of highest strain in the dent. | |
| A plurality of general metal loss indications | The dent likely |
| distributed within the dent. | comprises corrosion. |
| A strong metal loss indication located at the | The dent likely |
| apex of the dent or the region of highest strain | comprises a crack |
| in the dent and one or more weaker metal loss | and/or a gouge. |
| indications located elsewhere in the dent (e.g., | |
| surrounding the strong metal loss indication). | |
| A strong metal loss indication located at the | The dent likely |
| apex of the dent or the region of highest strain | comprises a gouge. |
| in the dent and also oriented at least partially | |
| (or substantially) circumferentially relative to | |
| the pipe. | |

FIG. 4A shows a flowchart of another exemplary method, generally shown at 400, for characterizing a dent in pipe. Method 400 may have some similarities with method 300 and may be used in conjunction with the strain severity (i.e., first) criterion and the metal loss (i.e., second) criterion previously described above. Method 400 may also be used in conjunction with the ILI tool 10 and measuring devices 16A, 16B. As mentioned above, the strain severity criterion may be used to assess whether dent 14 may be susceptible to cracking. In some applications and in some embodiments of the methods disclosed herein, if dent 14 does not meet the strain severity criterion, no further analysis may be required. Alternatively, in various embodiments, further analysis may be considered to ensure no defects other than corrosion are associated with the dent. For example, surface breaks and/or other manufacturing defects may be present and may require further investigation even though the risk of crack(s) associated with dent 14 may be considered to be relatively low based on the strain severity criterion. However, in some cases, only those dents meeting the strain criterion may be considered as candidates for further investigation with the metal loss (e.g., MFL signal characteristics) criterion. In some cases, dents may meet the strain severity criterion as a pre-requisite for cracking regardless of whether the dent is reported as a plain dent or a dent with some metal loss indications (e.g., features).

Accordingly, method 400 may comprise decision block 402 at which strain data 24 is evaluated according to known or other methods to determine whether the strain severity (i.e., first) criterion has been met. If the strain severity criterion has been met, then evaluation of MFL data 26 may be conducted to characterize dent 14. At decision block 404, MFL data 26 may be evaluated according to known or other methods to determine if the second criterion has been met for one or more of a crack and gouge. If the strain severity criterion has not been met by dent 14, further action may still be considered depending on the specific application. Examples of the second criterion are presented in Table 1 above and may be used to determine that dent 14 likely comprises at least one of a gouge, crack, and (e.g., alternatively) corrosion as explained above. For example, even though the strain severity criterion may not have been met at decision block 402, consideration of MFL data 26 may optionally be conducted to still characterize dent 14 as comprising corrosion and/or other defects (see block 408). For example, in various embodiments, the determination as to whether any corrective or preventative action is required may be made based on the characterization of dent 14 whether or not the strain severity criterion has been met at decision block 402.

FIG. 4B shows a flowchart of another exemplary method, generally shown at 450, for characterizing a dent in pipe 12. Method 450 may have some similarities with methods 300, 400 and may be used in conjunction with the strain severity criterion and the metal loss criterion previously described above. However, in contrast with method 400 of FIG. 4A, method 450 may include the evaluation of the metal loss criterion (see block 452) before the evaluation of the strain severity criterion (see block 454). In some applications and in some embodiments of the methods disclosed herein, if dent 14 does not meet the metal loss criterion, no further analysis may be required. However, in some cases, those dents meeting the metal loss criterion may be considered as candidates for further investigation with the strain severity criterion. In some cases, dents may meet the metal loss criterion as a pre-requisite for further consideration.

Accordingly, method 450 may comprise decision block 452 at which MFL data 26 is evaluated according to known or other methods to determine whether the metal loss criterion has been met. The metal loss criterion may comprise one or more threshold characteristics such as, for example, a magnitude, area, number of instances and/or combinations thereof, against which MFL data 26 may be evaluated. If the metal loss criterion has been met, then evaluation of strain data 24 may be conducted to characterize dent 14. At decision block 454, strain data 26 may be evaluated according to known or other methods to determine if the second criterion has been met for one or more of a crack and gouge (see block 456) or for one or more of corrosion, surface break and manufacturing defect (see block 458). If the strain severity criterion has not been met by dent 14 at decision block 454, further action may still be considered depending on the specific application and characteristics of the MFL data 26.

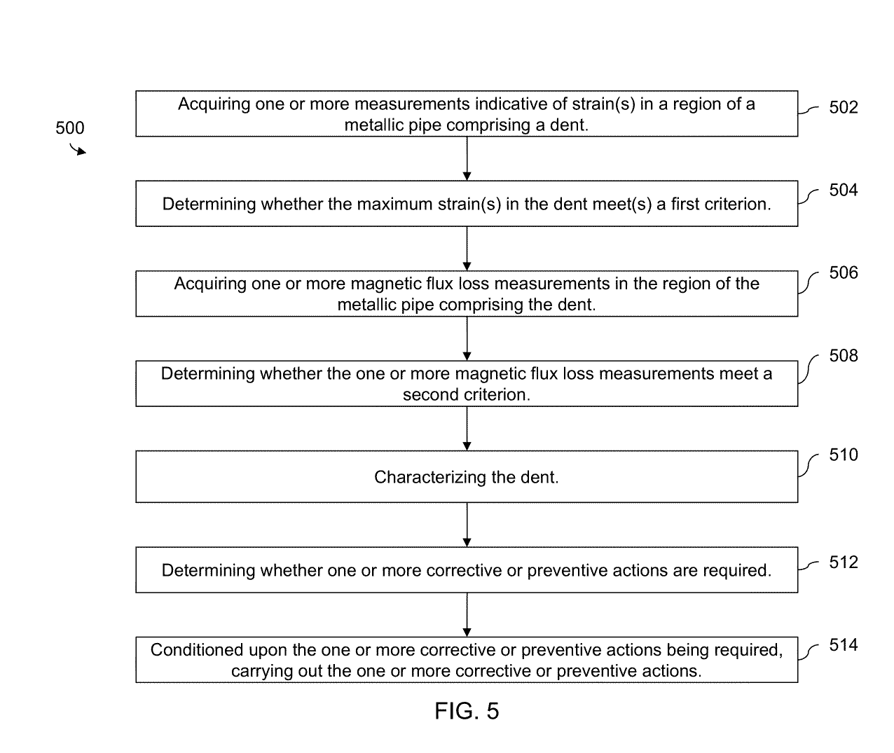

FIG. 5 shows a flowchart of another exemplary method, generally shown at 500, in accordance with the present disclosure. Method 500 may have some similarities with other methods described herein and may be used in conjunction with the strain severity (i.e., first) criterion and the material loss (i.e., second) criterion previously described above. Method 500 may also be used in conjunction with ILI tool 10 and measuring devices 16A, 16B. Pipe 12 may comprise a metallic material such as an API-grade steel for pipelines.

For example, method 500 may comprise: acquiring one or more measurements indicative of strain(s) in a region of a metallic pipe 12 comprising dent 14 (see block 502); determining whether the maximum equivalent strain meets a first criterion (see block 504); acquiring one or more MFL measurements in the region of metallic pipe 12 comprising dent 14 (see block 506); determining whether the one or more MFL measurements meet a second criterion (see block 508); conditioned upon the strain meeting the first criterion and the one or more magnetic flux leakage measurements meeting the second criterion: characterizing dent 14 (see block 510); and determining whether one or more corrective or preventive actions are required (see block 512); and conditioned upon the one or more corrective or preventive actions being required, carrying out the one or more corrective or preventive actions. The characterization of dent 14 may comprise determining that the dent comprises at least one of a crack, gouge and corrosion based on a combination of the first criterion and of the second criterion.

The one or more corrective or preventive actions may comprise making a dig selection based on the combined findings discussed above and proceeding with field investigations and validation. For example, the one or more corrective or preventative actions may comprise excavating at least a portion of pipe 12 in order to conduct a visual or other type of inspection of pipe 12. The one or more preventive or corrective actions may comprise the repair or replacement of the portion of pipe 12 comprising dent 14.

At least portions of the exemplary methods disclosed herein may computer implemented and may be carried out using one or more computers comprising data processor(s) 22 configured to receive strain data 24 and MFL data 26, process the received data 24, 26 and output one or more signals 30 representative of dent characterization. Computer implementation of at least portions of the methods described herein may be carried by data processor(s) 22 in accordance with instructions 28. An exemplary computer-implemented version of methods disclosed herein may comprise: receiving one or more first signals 24 indicative of strain(s) in the material in a region of dent 14; processing the received first signals 24 to determine whether the maximum equivalent strain meets a first criterion; receiving one or more second signals 26 indicative of material loss in the region of dent 14; processing the received second signals 26 to determine whether the material loss meets a second criterion; and conditioned upon the maximum equivalent strain meeting the first criterion and the material loss meeting the second criterion, generating one or more signals 30 characterizing the dent as comprising at least one of a crack and a gouge based on the combination of the first criterion and of the second criterion.

Such computer-implemented methods may be used in conjunction with the strain severity (i.e., first) criterion and the material loss (i.e., second) criterion previously described above. Such computer-implemented methods may also be used in conjunction with ILI tool 10 and measuring devices 16A, 16B.

In various embodiments, the acquisition of measurement(s) indicative of strain and/or magnetic flux leakage may include taking measurements using measuring devices 16A, 16B. Alternatively, the acquisition of measurements indicative of strain and/or magnetic flux leakage may include receiving values representative of such measurements previously taken by another party. For example, the taking of measurements may be conducted by the same or a different party than the party conducting the characterization of dents in the pipeline. For example, the taking of measurements of the pipeline may be conducted by a service provider and the processing of the measurements for the purpose of characterizing dents in the pipeline may be conducted by an owner, operator and/or custodian of the pipeline.

The detailed examples (EXAMPLES 1-5) provided below are extracted from a case study performed utilizing combined Caliper (i.e., dimensional) and MFL (i.e., material loss) inspections. The inspections reported thousands of dents. First, the dents were screened based on the strain value, which was calculated using point-to-point dent strain assessment software using dent profile data reported from ILI tool 10. Then, the DFDI value for each dent was computed and ranked in descending order. For the purpose of the case study, a DFDI limit was set to 0.6 to identify dents that required a review of MFL data in addition to all reported dents comprising a metal loss indication. The DFDI limit was chosen based on the confidence level and certainty of the measurement by the dent geometrical measuring device 16A, and based on a conservative material critical strain but it is understood that the DFDI limit may be selected and fine-tuned based on feedback from excavations and the specific application. Finally, examination of MFL data was performed within the dent region for the short-listed dents. Then, appropriate mitigation was prepared and appropriate field investigations were conducted for the short-listed dents. Eight dents were short-listed for the performance of a detailed review of MFL data characteristics and also selected for excavation.

The excavation showed that, among the eight dents, one that was initially reported as a dent associated with 76% metal loss was correctly characterized as a dent with a crack and three dents that were initially reported as plain dents were correctly characterized as dents with crack/gouge. The field investigation further showed, following excavations, that two of the three “plain” dents contained through-wall cracks and were leaking (see EXAMPLE 3).

### Example 1

### Dent with Branched Cracks

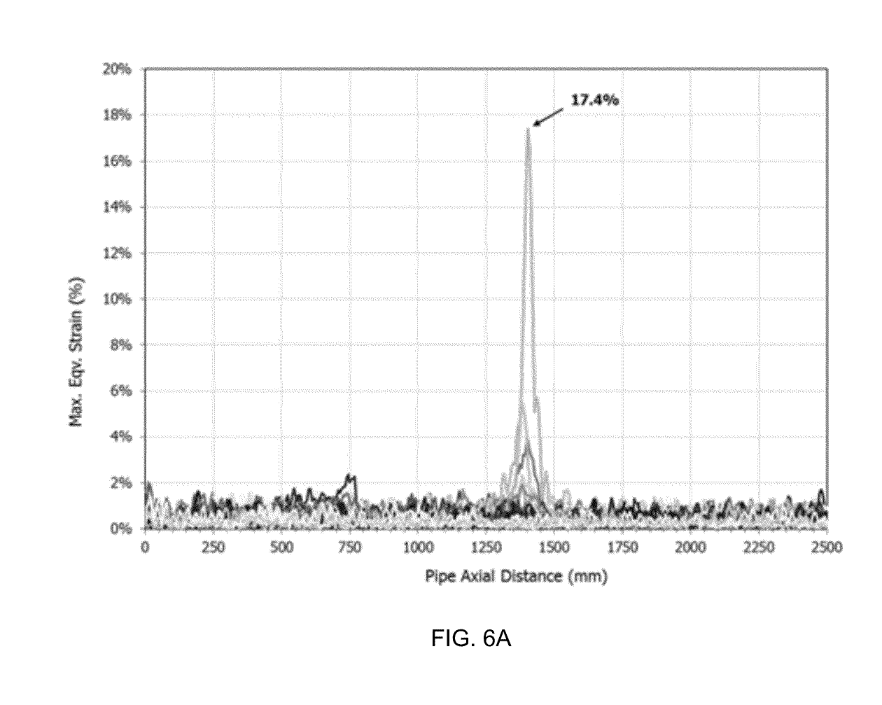

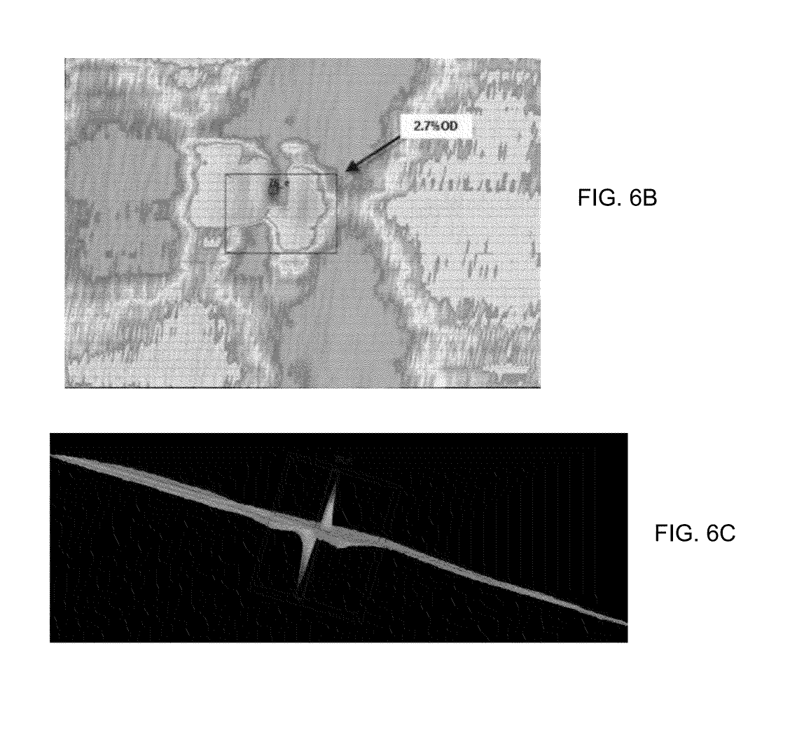

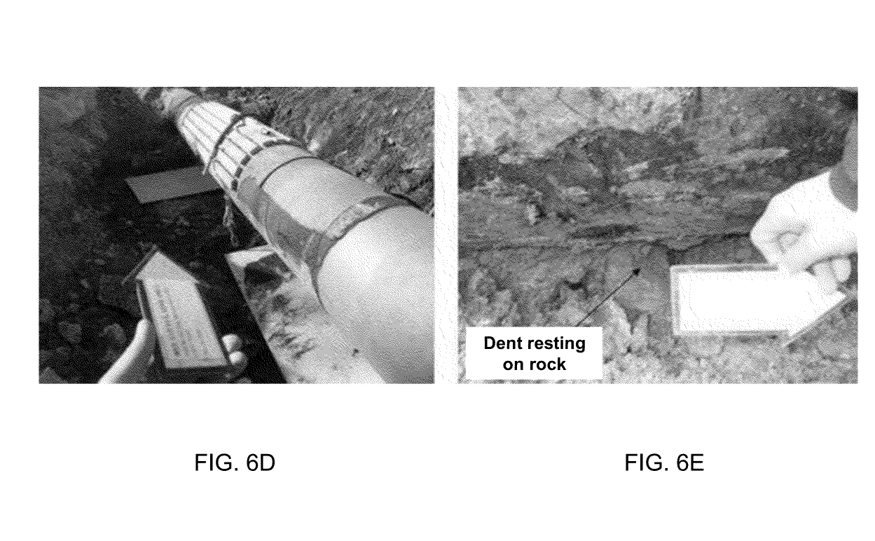

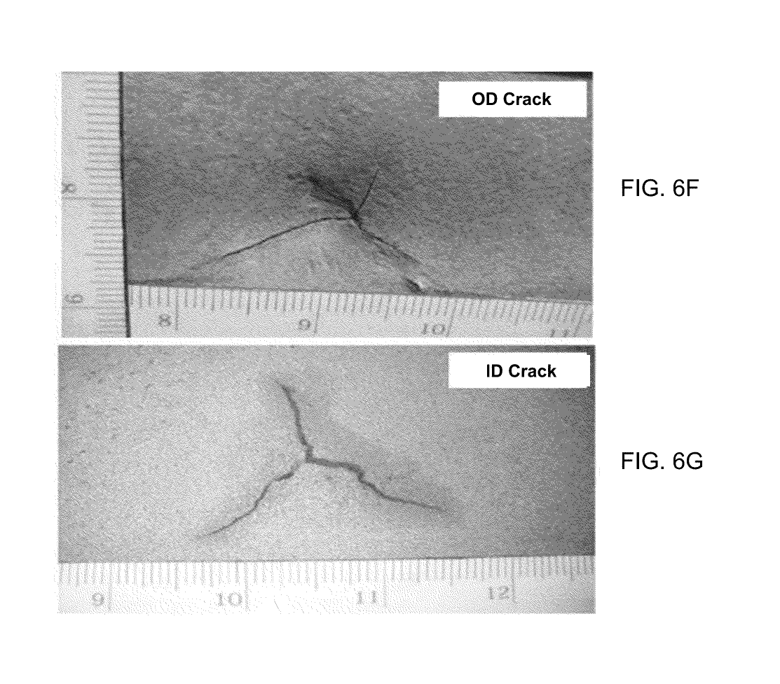

For this first exemplary dent, a combined caliper and tri-axial MFL ILI reported a bottom side 2.7% outside diameter (OD) dent associated with 76% metal loss. The strain analysis of this dent using ILI dent profile showed a maximum equivalent strain of 17.4% (see FIG. 6A). In addition, the DFDI for this first exemplary dent was calculated to be 0.97, which met the first (strain severity) criterion required for further MFL data characterization.

FIGS. 6B and 6C are top and side screen shots of MFL data in the dent, showing a strong single deep metal loss indication located at the dent apex. The type of signal is typical for pit metal loss. However, because it was coincident with the dent apex where the strain was highest, and there were no other metal loss signals or clusters around this single sharp signal in the dent area, this indicated that the associated 76% metal loss was most likely a crack. Therefore, this dent was selected for immediate excavation.

FIGS. 6D and 6E show an excavated region of a pipe comprising the first exemplary dent. Following the excavation, an in-ditch investigation was conducted. FIGS. 6F and 6G show images of cracks associated with the first exemplary dent on the outside and on the inside of a wall of the pipe respectively. The investigation showed that the first exemplary dent was associated with branched cracks emitted from the apex of the dent, but no leaks were detected.

### Example 2

### Dent with Gouge

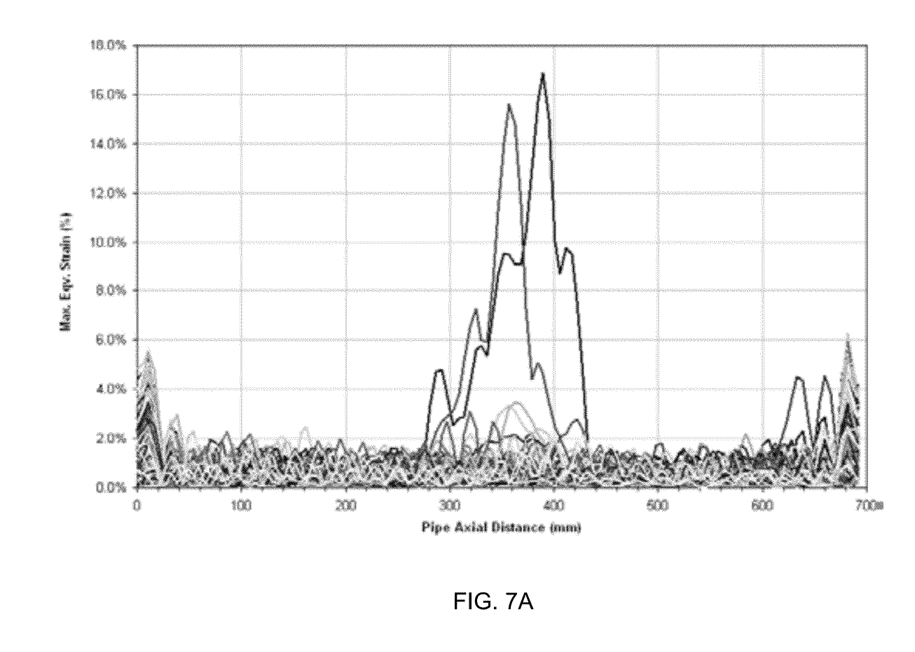

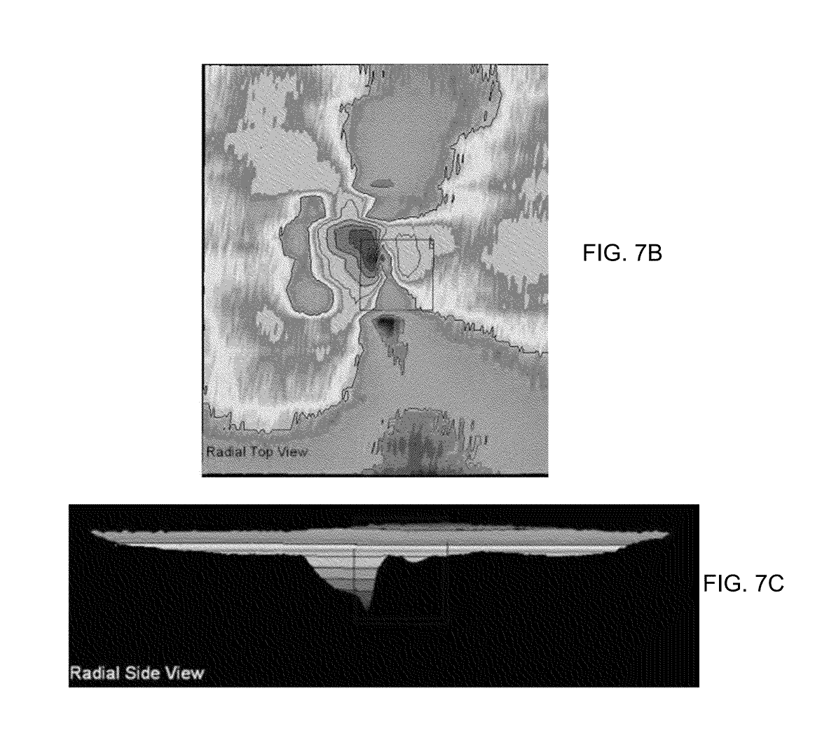

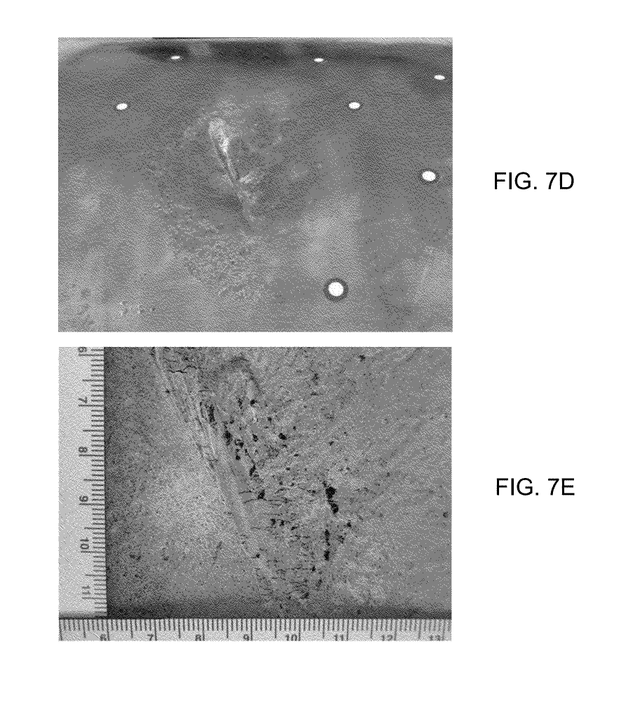

This second exemplary dent was a top side dent with 2.7% OD (20 mm) in depth. It is noted that this dent was initially reported as “plain” dent because the metal loss data was below the reportable threshold. The strain analysis was performed on this dent using the ILI dent profile data, showing a maximum equivalent strain of about 16.9% as shown in FIG. 7A. The high strain level associated with this dent indicated that the dent may have been associated with a crack or gouge. In addition, the calculate DFDI for this dent was 0.9, which indicated that the strain severity criterion had been met and that this dent was a candidate for a more detailed review and characterization of its MFL data.

FIGS. 7B and 7C are top and side screen shots of MFL data for this dent. The MFL screen shots indicated that this dent was likely not a plain dent. There was an indication of metal loss inside the dent but different from the deep pit signal in EXAMPLE 1. The metal loss signal appears to be in the circumferential orientation relative to the pipe and quite blunt, suggesting that the metal loss is more likely a gouge oriented circumferentially which resulted in a wider but blunt circumferential MFL indication.

Since this second exemplary dent was associated with a high strain level with suspicious MFL data and was located on the top side of the pipe, it was selected for excavation. FIG. 7D shows the in-ditch examination of this dent feature, which clearly shows that the dent was associated with a gouge. FIG. 7E is another image of the gouge taken a higher magnification and shows that a number of axial cracks had also initiated.

### Example 3

### Leaking Dent

A combination of Caliper/MFL inspection of another pipe segment reported 1750 dents. First, dent severity screening was done using strain calculation. Based on the high strain level and DFDI criteria, eight dents were shortlisted for detail MFL signal review and characterization. Following MFL review, two dents (EXAMPLE 3 and EXAMPLE 4 below) were identified for further investigation and excavation. These third and fourth exemplary dents were later found to be associated with through-wall cracking and leaking. The strain analysis result, MFL review and field findings of these two dents are summarized below.

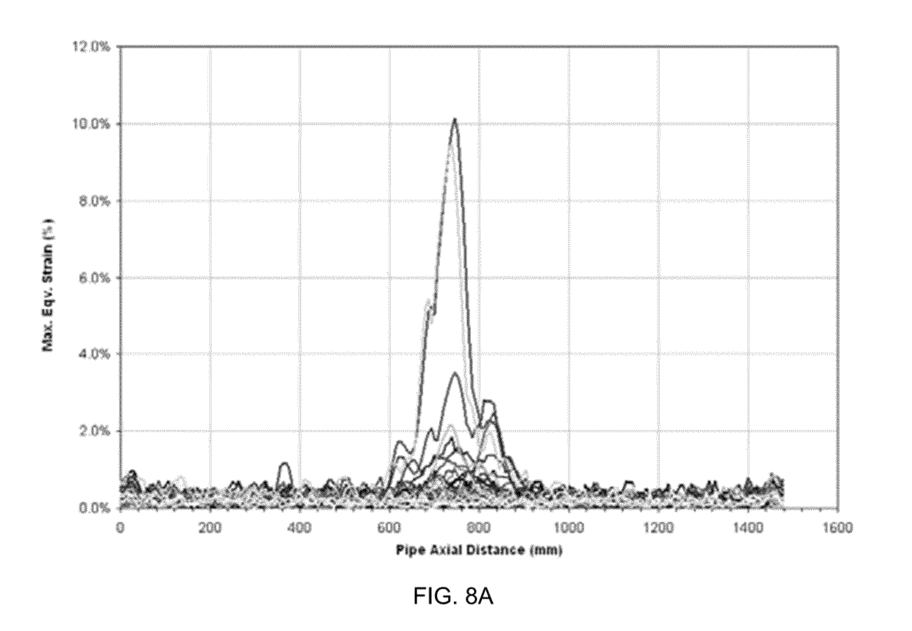

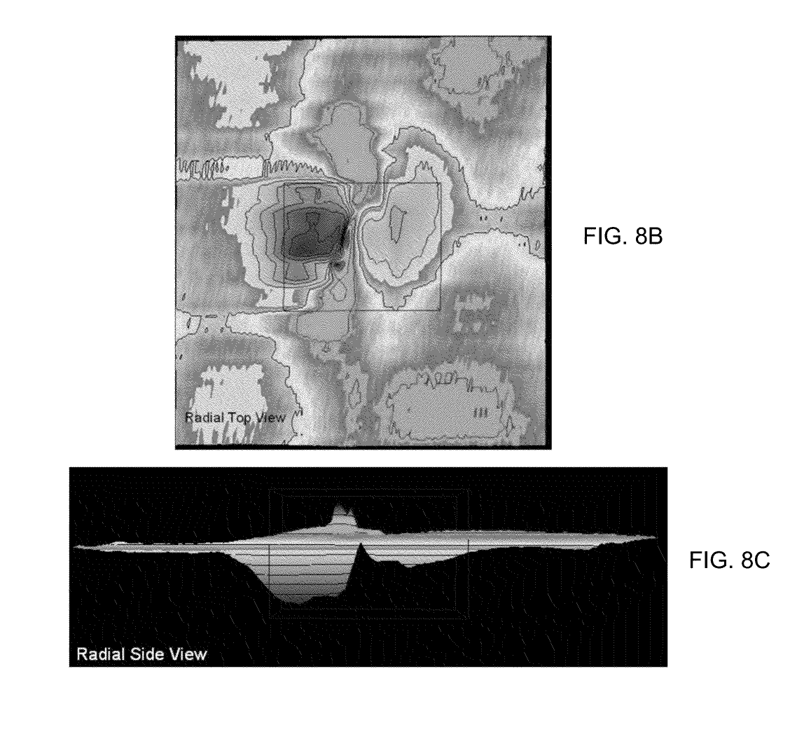

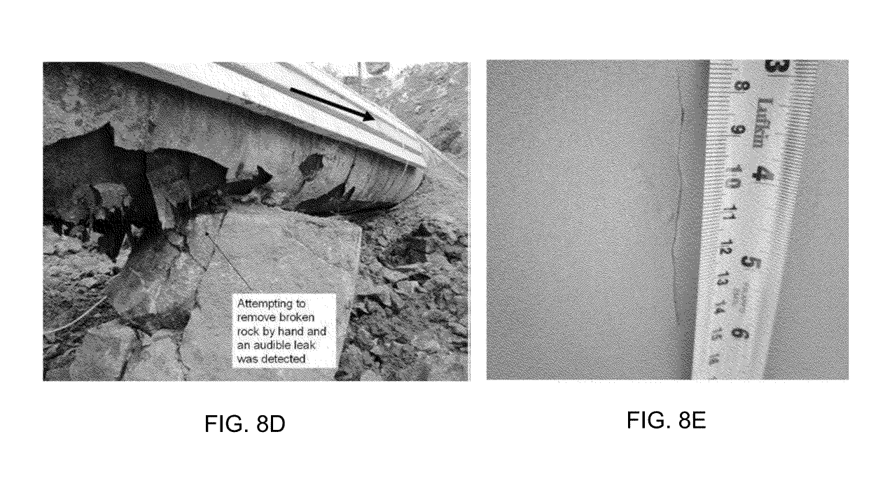

For EXAMPLE 3, ILI again reported this dent as a plain dent located on a bottom side of the pipe and having depth of 4.4% OD (33.5 mm). The maximum equivalent strain associated with this dent was calculated to be 10.2% (see FIG. 8A). The calculated DFDI was 0.6, which met the strain severity criterion and which meant that this dent was a candidate for a more detailed review and characterization of its MFL data.

FIGS. 8B and 8C are top and side screen shots of MFL data for this dent. The MFL data indicates that it is not a plain dent signal. There is sharp indication that is not typical corrosion signal. It is oriented more circumferentially than axially and therefore indicated either a crack or gouge.

Since this dent was associated with a high strain level and with suspicious MFL data and also that it was located on a bottom side of the pipe, it was selected for excavation. FIG. 8D shows the in-ditch excavation of the pipe. During the excavation, an audible leak was detected while attempting to manually remove broken rock and this indicated that the dent was associated with a through-wall crack. After sandblasting a cut-out portion of the pipe, a circumferential through wall crack measuring about 70 mm in length could be seen by visual inspection (see FIG. 8E).

### Example 4

### Leaking Dent

This fourth exemplary dent is the second of the three leaking dents described as examples herein. Notably, this dent was also initially reported as a plain dent located at 5:47 o'clock with depth of 4.1% OD (31.2 mm).

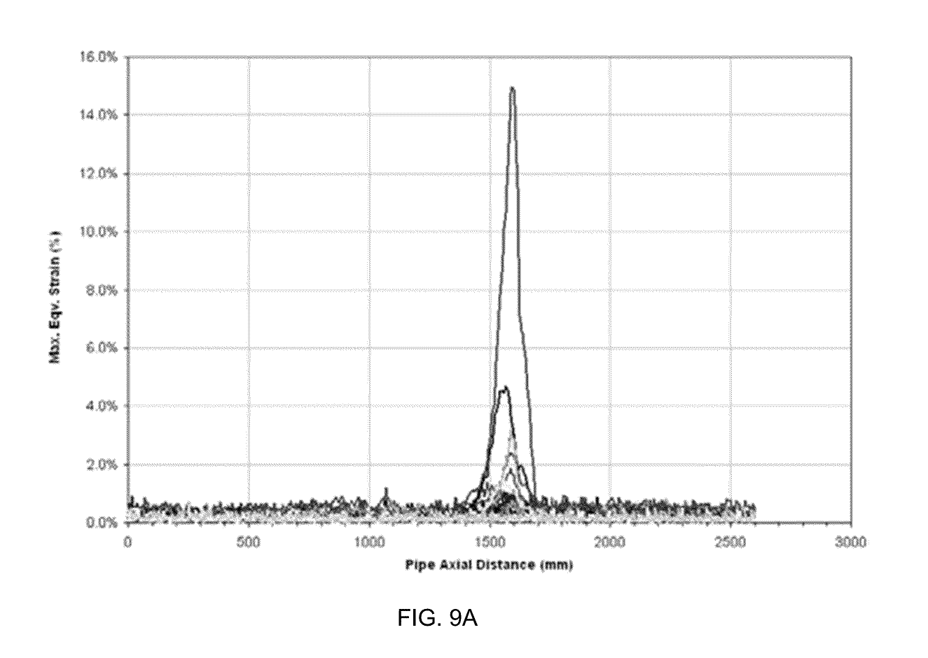

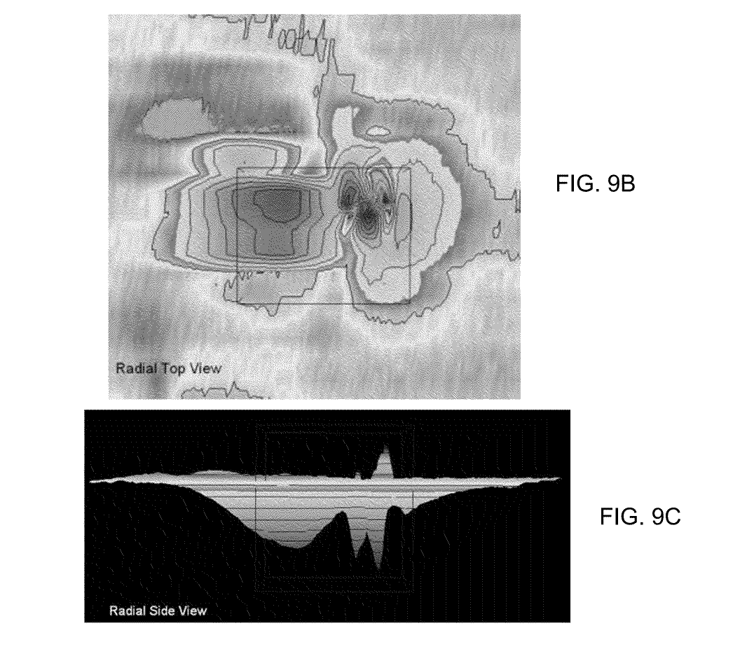

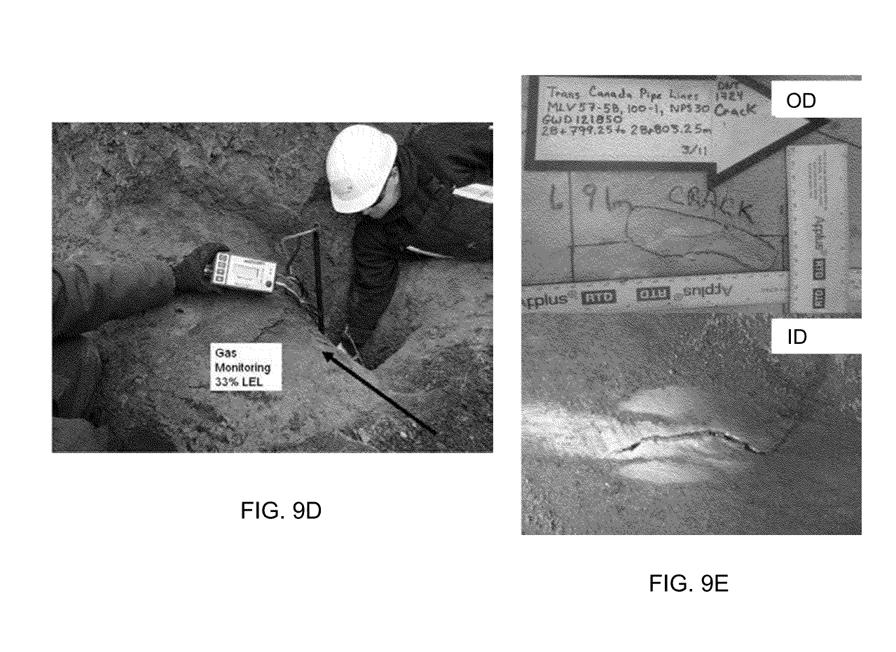

The maximum equivalent strain associated with this dent was about 15% as shown in FIG. 9A. The calculated DFDI was 0.8, which met the strain severity criterion and which meant that this dent was also a candidate for a more detailed review and characterization of its MFL data.

FIGS. 9B and 9C are top and side screen shots of MFL data for this dent. Again this was not a plain dent signal. Instead, there were two sharp metal loss indications inside the dent but from the sharpness, the metal loss feature indications were characterized as being more likely a crack or a gouge.

Since this dent was associated with high strain level with suspicious MFL data, it was selected for excavation. FIG. 9D shows the in-ditch excavation of the portion of pipe in question. It was found that this dent was associated with a through wall crack. During the excavation, gas monitoring detected 33% of the lower explosive limit (LEL). FIG. 9E shows a close-up view of the crack on the outside of the pipe wall (see upper portion of FIG. 9E) and on the inside of the pipe wall (see lower portion of FIG. 9E) after a portion of the pipe containing the crack had been cut out from the pipe.

The field investigation further indicated that the crack was oriented substantially along the axial direction (FIG. 9E), however, at one end of the crack, the orientation changed to about 45 degrees from the axial direction. It is likely this portion of the crack that caused the metal loss indication to be detected.

### Example 5

### Leaking Dent

This fifth exemplary dent is the third of the three leaking dents described as examples herein. This dent was reported as a dent located at 7:15 o'clock with depth of 3.93% OD (30 mm), associated with a 36% metal loss.

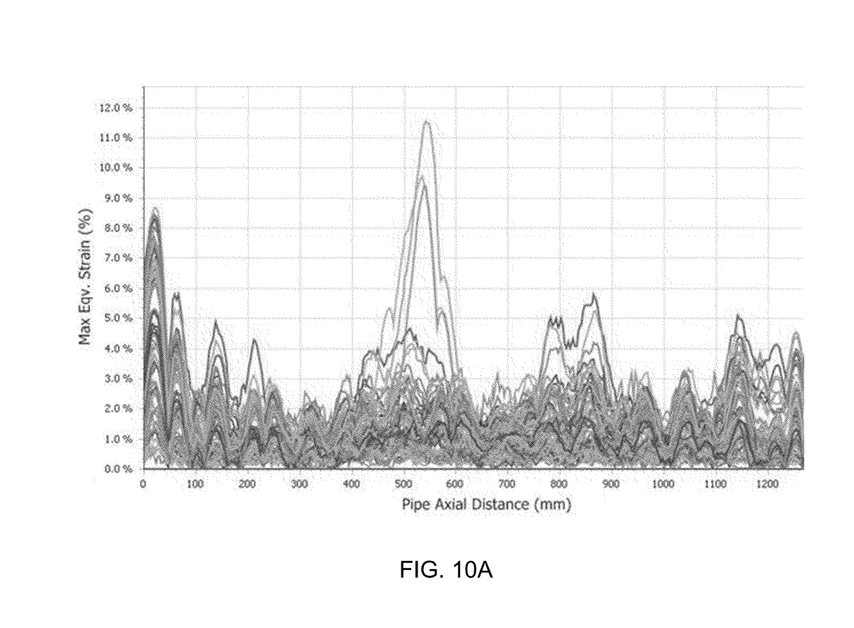

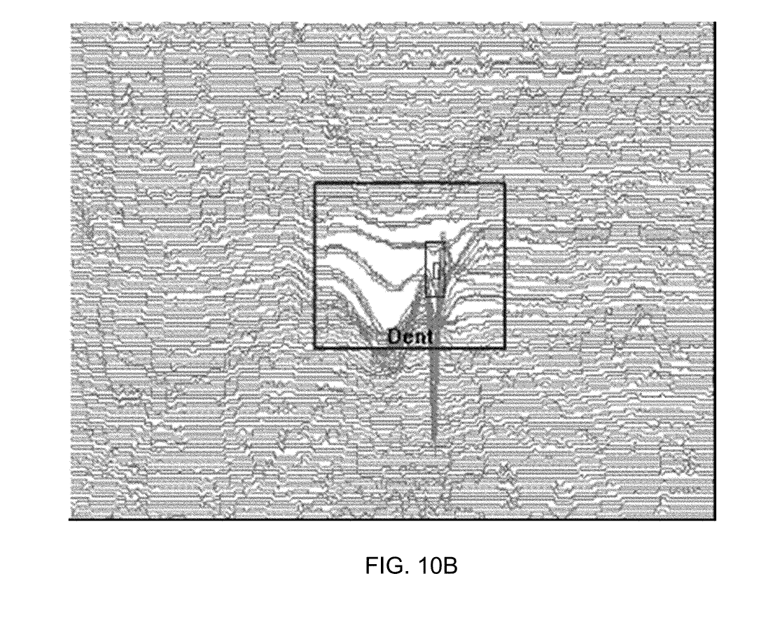

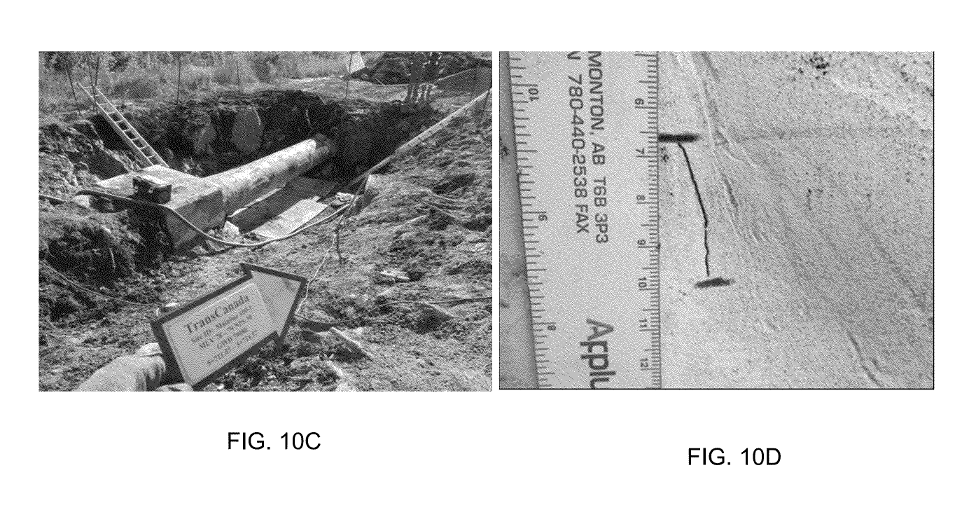

The maximum equivalent strain associated with this dent was about 11.5% as shown in FIG. 10A. The calculated DFDI was 0.63, which met the strain severity criterion and which meant that this dent was also a candidate for a more detailed review and characterization of its MFL data.

FIG. 10B is a screen shot of axial MFL data for this dent. The MFL screen shot indicates there is a metal loss signal inside the dent region. The metal loss signal appears to be sharp and to have deep ML signal characteristics, suggesting that the metal loss is likely due to a crack.

Since this dent was associated with high strain level with suspicious MFL data, it was selected for excavation. FIG. 10C shows the in-ditch excavation of the portion of pipe in question. It was found that this dent was associated with a through wall crack. During the excavation, leaking gas was identified. FIG. 10D shows a close-up view of the crack on the outside of the pipe.

The methods and devices disclosed herein may be used to combine dent strain analysis and MFL signal characterization as part of a dent integrity management program in pipelines. In some applications, field excavation examinations demonstrated the effectiveness of this combined approach in the identification of cracks from thousands of ILI reported “plain” dents and discriminate dents with cracks from dents associated with metal loss. The disclosed methods and devices which may be used to combine strain and MFL characterization may also be used in conjunction with other, different methods and devices to disclosed herein based on specific applications.

In various embodiments, the methods and devices of the present disclosure may have similarities with those described in the following publications: (1) “A Combined Approach to Characterization of Dent with Metal Loss” by R. Wang, R. Kania, U. Arumugam and M. Gao, Proceedings of IPC2012, 9th International Pipeline Conference, Sep. 24-28, 2012, Calgary, Canada; and (2) “Characterization of Plastic Strain Damage and MFL Signals for Discrimination of Cracks/Gouge/Corrosion in Dents—A Combined Approach” by R. Wang, R. Kania, U. Arumugam and M. Gao, Proceedings of the 19th JTM on Pipeline Research, 29 Apr.-3 May 2013, Sydney, Australia. Both of the above publications are incorporated herein by reference in their entirety.

The above description is meant to be exemplary only, and one skilled in the relevant arts will recognize that changes may be made to the embodiments described without departing from the scope of the invention disclosed. For example, the blocks and/or operations in the flowcharts and drawings described herein are for purposes of example only. There may be many variations to these blocks and/or operations without departing from the teachings of the present disclosure. For instance, the blocks may be performed in a differing order, or blocks may be added, deleted, or modified. The present disclosure may be embodied in other specific forms without departing from the subject matter of the claims. Also, one skilled in the relevant arts will appreciate that while the methods, devices and tools disclosed and shown herein may comprise a specific number of elements/components, the methods, devices and tools could in some applications be modified to include additional or fewer of such elements/components. The present disclosure is also intended to cover and embrace all suitable changes in technology. Modifications which fall within the scope of the present invention will be apparent to those skilled in the art, in light of a review of this disclosure, and such modifications are intended to fall within the appended claims.

What is claimed is:

1. A method for characterizing a dent in a pipeline, the method comprising;
using a first measuring device, acquiring one or more first measurements indicative of strain in the pipeline in a region of the dent;
using a second measuring device, acquiring one or more second measurements indicative of a material loss in the region of the dent; and
conditioned upon the strain meeting a first criterion and the material loss meeting a second criterion, determining that the dent comprises at least one of a crack and a gouge based on a combination of the first criterion and of the second criterion.

2. The method as defined in claim 1, wherein the one or more second measurements comprise one or more magnetic flux leakage measurements.

3. The method as defined in claim 1, wherein the first criterion comprises a strain severity criterion.

4. The method as defined in claim 1, wherein the first criterion comprises a ductile failure damage indicator (DFDI) equalling or exceeding a predetermined value where the DFDI is defined as:
$$DFDI = \frac{{ɛ}_{eq , m ax}}{( \frac{{ɛ}_{0}}{1.65} )} ,$$
ε_{eq,max} being a maximum equivalent strain calculated from the one or more first measurements and ε₀ being a critical strain of the material.

5. The method as defined in claim 4, wherein the predetermined value is about 0.6.

6. The method as defined in claim 4, wherein the predetermined value is selected based on a confidence level and certainty of at least one of the measurements acquired.

7. The method as defined in claim 4, wherein the predetermined value is about 1.

8. The method as defined in claim 1, wherein conditioned upon the second criterion comprising a substantially isolated strong metal loss indication located at a region of highest strain in the dent, determining that the dent comprises the crack.

9. The method as defined in claim 1, wherein conditioned upon the material loss comprising a plurality of metal loss indications distributed within the dent, determining that the dent comprises corrosion.

10. The method as defined in claim 1, wherein the second criterion comprises a strong metal loss indication located at a region of highest strain in the dent and one or more weaker metal loss indications located elsewhere in the dent.

11. The method as defined in claim 1, wherein conditioned upon the second criterion comprising a strong metal loss indication located at a region of highest strain in the dent and also oriented at least partially circumferentially relative to the pipe, determining that the dent comprises the gouge.

12. The method as defined in claim 1, comprising evaluating the second criterion only if the first criterion has been met.

13. A method comprising:
acquiring one or more measurements indicative of strain in a region of a metallic pipe comprising a dent;
determining whether the strain meets a first criterion;
acquiring one or more magnetic flux leakage measurements in the region of the metallic pipe comprising the dent;
determining whether the one or more magnetic flux leakage measurements meet a second criterion;
conditioned upon the strain meeting the first criterion and the one or more magnetic flux leakage measurements meeting the second criterion:
determining that the dent comprises at least one of a crack and a gouge based on a combination of the first criterion and of the second criterion; and
determining whether one or more corrective or preventive actions are required; and
conditioned upon the one or more corrective or preventive actions being required, carrying out the one or more corrective or preventive actions.

14. The method as defined in claim 13, wherein the one or more corrective or preventive actions comprises conducting an evaluation of the region of the dent in the pipe.

15. The method as defined in claim 13, wherein the first criterion comprises a predetermined ductile failure damage indicator (DFDI) equalling or exceeding a predetermined value where the DFDI is defined as:
$$DFDI = \frac{{ɛ}_{eq , m ax}}{( \frac{{ɛ}_{0}}{1.65} )} ,$$
ε_{eq,max} being a maximum equivalent strain calculated from the one or more measurements indicative of the strain and ε₀ being a critical strain of a material of the pipe.

16. The method as defined in claim 15, wherein the predetermined value is about 0.6.

17. The method as defined in claim 15, wherein the predetermined value is about 1.

18. The method as defined in claim 15, wherein the predetermined value is selected based on a confidence level and certainty of at least one of the measurements acquired.

19. The method as defined in claim 15, wherein conditioned upon the second criterion comprising a substantially isolated strong metal loss indication located at a region of highest strain in the dent, determining that the dent comprises the crack.

20. The method as defined in claim 15, wherein conditioned upon the one or more magnetic flux leakage measurements comprising a plurality of metal loss indications distributed within the dent, determining that the dent comprises corrosion.

21. The method as defined in claim 15, wherein the second criterion comprises a strong metal loss indication located at a region of highest strain in the dent and one or more weaker metal loss indications located elsewhere in the dent.

22. The method as defined in claim 15, wherein conditioned upon the second criterion comprising a strong metal loss indication located at a region of highest strain in the dent and also oriented at least partially circumferentially relative to the pipe, determining that the dent comprises the gouge.

23. The method as defined in claim 13, wherein:
acquiring one or more measurements indicative of strain comprises taking one or more measurements indicative of strain; and
acquiring one or more magnetic flux leakage measurements comprises taking one or more magnetic flux leakage measurements.

24. A computer-implemented method for characterizing a dent in a pipeline, the method comprising;
receiving one or more first signals indicative of strain in the material in a region of the dent;
processing the received first signals to determine whether the strain meets a first criterion;
receiving one or more second signals indicative of material loss in the region of the dent;
processing the received second signals to determine whether the material loss meets a second criterion; and
conditioned upon the strain meeting the first criterion and the material loss meeting the second criterion, generating one or more signals characterizing the dent as comprising at least one of a crack and a gouge based on the combination of the first criterion and of the second criterion.

25. The method as defined in claim 24, wherein the one or more second signals are indicative of magnetic flux leakage measurements.

26. The method as defined in claim 24, wherein the first criterion comprises a ductile failure damage indicator (DFDI) equalling or exceeding a predetermined value where the DFDI is defined as:
$$DFDI = \frac{{ɛ}_{eq , m ax}}{( \frac{{ɛ}_{0}}{1.65} )} ,$$
ε_{eq,max} being a maximum equivalent strain calculated from the one or more first measurements and ε₀ being a critical strain of the material.

27. The method as defined in claim 26, wherein the predetermined value is greater than about 0.6.

28. The method as defined in claim 26, wherein the predetermined value is selected based on a confidence level and certainty of at least one of the signals received.

29. The method as defined in claim 24, wherein conditioned upon the second criterion comprising a substantially isolated strong metal loss indication located at a region of highest strain in the dent, determining that the dent comprises the crack.

30. The method as defined in claim 24, wherein conditioned upon the material loss comprising a plurality of metal loss indications distributed within the dent, determining that the dent comprises corrosion.

31. The method as defined in claim 24, wherein the second criterion comprises a strong metal loss indication located at a region of highest strain in the dent and one or more weaker metal loss indications located elsewhere in the dent.
